(19) United States
(12) Patent Application Publication
(10) Pub. No.: US 2004/0231607 A1
(43) Pub. Date: Nov. 25, 2004

(54) Bowl with suction cup for pet

(75) Inventor: Fred Hollinger, Kings Park, NY (US)

Correspondence Address: Fred Hollinger, 59 Boxwood Drive, Kings Park, NY, 11754, US

(73) Assignee: E&B Giftware LLC., Yonkers, NY

(21) Appl. No.: 10/431,589

(22) Filed: May 6, 2003

(51) Int. Cl. A01K 1/10

(52) U.S. Cl. 119/61.54

(57) ABSTRACT

A pet bowl having an interior dished portion for receiving pet food, water or the like has a rather large suction cup held centrally to the underside of the pet bowl for securing the bowl to a surface such as a floor. The pet bowl includes a sidewall extending from an upper portion to a lower portion and enclosing an open area adjacent the upper portion, with the interior dished portion sloping inwardly from the upper portion of said sidewall. A bottom wall extends beneath the dished portion and the suction cup is held beneath a central portion of the bottom wall to secure the pet bowl to a support surface to hold the pet bowl in place as a pet consumes material within the dished portion. The central portion of the bottom wall is domed shape to conform generally to the contours of the suction cup. The surface of the suction cup preferably has upstanding portions to engage the undersurface of the bottom portion to depress the suction cup assuredly upon downward movement of the bowl, and is held to the central portion of the bottom wall by a knob press-fitted into a central opening. Further, a tab may extend from the rim portion of the suction cup to be accessed through an opening in the sidewall of the pet bowl for enabling the rim of the suction cup to be lifted to release the suction cup from the support.

### FIELD OF THE INVENTION

The present invention relates to a pet bowl having a suction cup attached to its base to secure the pet bowl to a floor during use.

### PRIOR APPLICATION

This application is a continuation of my application filed Apr. 25, 2003 as attorney docket number 505-059.

### BACKGROUND OF THE INVENTION

Bowls for holding food or water for pets such as dogs are well known, and typically the bowls are formed of a side wall adapted to be rested onto a kitchen floor or the like with an interior dished portion for holding food or water. In use, the pet will place his muzzle in the dished portion and often cause the bowl to slide along the floor. To help secure the pet bowl onto the floor or other supportive surface, it has been proposed to provide a plurality of suction cups on the bottom of the pet bowl, as shown, for example in U.S. Pat. No. 5,00,123 to Morse et al., U.S. Pat. No. 6,167,840 granted to White et al. and U.S. design Pat. No. Des. 333,886 to Kennedy. U.S. Pat. No. 2,969,890 to Udell has a cap portion fixed to the bottom of the pet bowl to extend through an opening in the suction cup, and my pending application Ser. No. 10/139,819 filed May 2, 2002 discloses a pet dish with a domed shaped bracket to hold the suction cup removably to the bowl.

It is desirable to remove the suction cup from the pet bowl for cleaning, particularly when the pet bowl is to be placed in a an automatic dishwasher using harsh detergents. It is also desirable to provide a pet bowl made from synthetic materials. It is, therefore, an object of the present invention to provide a pet bowl that may be manufactured inexpensively with synthetic materials such as plastic resins and yet may be sturdy and securely hold a suction cup that may be removed for cleaning.

### SUMMARY OF THE INVENTION

According to the present invention, a pet bowl for holding material to be consumed by a pet includes a sidewall extending from an upper portion to a lower portion and enclosing an open area adjacent the upper portion. A dished portion for receiving material to be consumed by a pet extends inwardly from the upper portion of the sidewall, and a bottom wall underlies the dished portion and is connected around the lower portion of the sidewall. A suction cup is held beneath a central portion of the bottom wall and extends to underlie at least a major portion of the lateral extent of the dished portion of the bowl. The suction cup may be secured to a support surface to hold the pet bowl in place as a pet consumes material within the dished portion.

The central portion is domed shape to conform generally to the contours of the suction cup and the suction cup may have an upstanding knob adapted to be press-fitted through an opening in the central portion to hold the suction cup removably. Additionally, the surface of the suction cup may have upstanding semicircular portions to engage the undersurface of the domed-shape central portion to depress the suction cup assuredly upon downward movement of the bowl, and the lower portion of the side wall may have an opening, and a tab upstanding from the suction cup may be accessible through the opening for releasing the suction cup from the surface.

In this way, the suction cup can be removed and the pet bowl placed, for example, in a dish washer for cleaning without needing to expose the suction cup to the hash environment of an automatic dish washer, and yet a sturdy pet bowl can be manufactured from relatively inexpensive synthetic materials and the suction cup can be secured assuredly to the support surface.

These and other objects, advantages and features of the present invention will become apparent from the description given below of a preferred embodiment, which description is made in conjunction with the following drawing figures, in which:

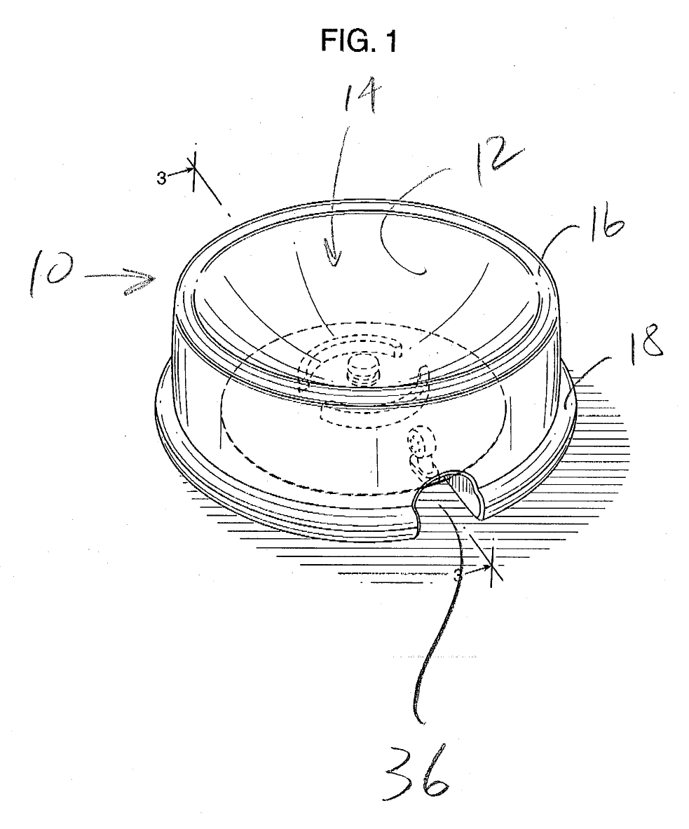

FIG. 1 is a perspective view of a pet bowl of the present invention;

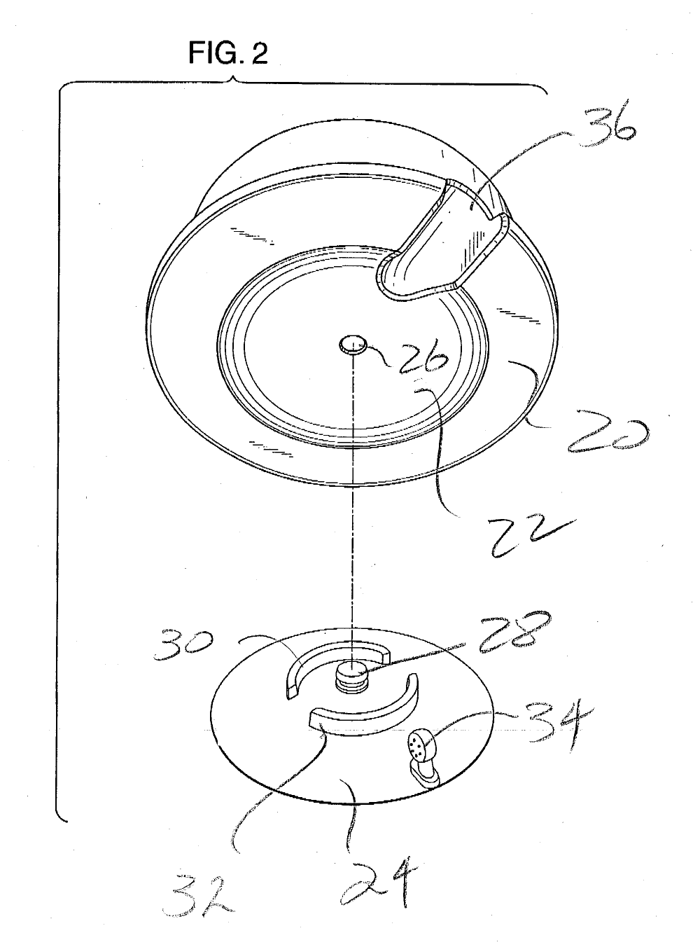

FIG. 2 is an exploded view of the pet bowl of FIG. 1;

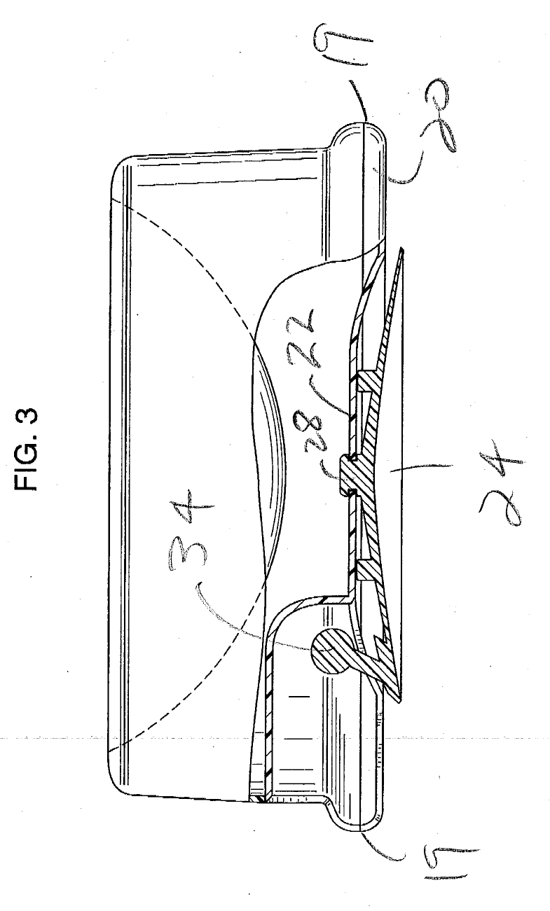

FIG. 3 is a cross-sectional view taken along line 3-3 of FIG. 1;

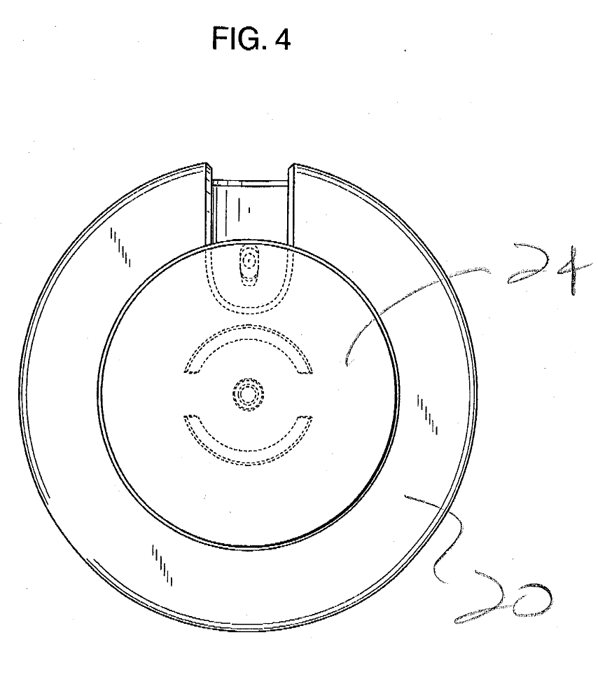

FIG. 4 is a bottom view.

As illustrated in FIG. 1, a pet bowl 10 of the present invention includes a sloping sidewall-12 leading to a central dished portion 14. Preferably, the side wall and dished portion are formed integrally from a molded synthetic material, and the sidewall 12 includes an upper portion 16 enclosing an open area leading to the dished portion 14, and a lower portion 18. A bottom wall 20 is connected around the lower portion 18 at joint 19 to extend beneath and underlie the entire dished portion 14, and has a domed-shaped central portion 22 of a shape conforming generally to the suction cup 24. The bottom wall 20 by being secured around the periphery of the lower portion of the sidewall 12 provides structural rigidity to the bowl to enable synthetic plastic materials to be used of reduced wall thickness to provide a sturdy yet light weight pet bowl.

The suction cup 24 underlies at least a major portion of the lateral extent of the dished portion 14 of the pet bowl, and as shown in FIG. 2, an opening 26 is formed centrally within the domed-shaped central portion 22; and an upstanding elastomeric knob 28 extends upwardly from the central portion of the suction cup 24 and has an enlarged end portion 29 which may be inserted through the opening 26 to secure the suction cup 24 removably to the domed-shaped central portion 22. The elastomeric knob 28 may be press-fitted through the opening 26.

The rim portion of the suction cup 24 extends below the lower edge of the sidewall 12 of the pet bowl as shown in FIG. 3, and placing the pet bowl on a supportive surface such as a kitchen floor and pressing downwardly will flatten the suction cup to hold the pet bowl to the surface. By use of a central suction cup that underlies at least a major portion of the lateral extent of the dished portion 14 of the pet bowl, pressing the pet bowl downwardly through the central portion of the dished portion 14 will enable the pet bowl to be held to a kitchen floor or the like simply and quickly.

In use, a pet such as a dog, may then push on the pet bowl while drinking water or eating food placed in the dished portion 14, and the pet bowl will likely be held in place to avoid spillage and movement of the pet bowl, and will not easily be worked loose.

The suction cup 24 has upstanding projections 30 and 32 adapted to engage the undersurface of the domed-shaped central portion 22. In this way, downward movement of the pet bowl 10 will cause the underside of the domed-shaped central portion 22 to press firmly against the projections 30 and 32 and assuredly depress the suction cup to a floor surface or the like. The projections 30 and 32 may, as illustrated, be a pair of semi-circular ridges arranged concentrically around the knob 28.

A tab 34 is connected integrally to the rim portion of the suction cup 24 and extends through a slotted opening 36 in the sidewall 12. After the pet bowl 10 has been secured and placed on a surface such as a kitchen floor by being pressed forcibly downward to provide a suction gripping the surface; the suction can be released by the user simply grasping the tab 34 and lifting to separate the adjacent lip of the rim portion of the suction cup from the surface to release the suction and enable the pet bowl to be removed.

These and other objects, advantages and features of the present invention will be understood from the detailed description of a preferred embodiment made above; however, the present-invention is not limited by any-details of the above but is set forth by the appended claims.

1. A bowl for holding material to be consumed by a pet, including a sidewall extending from an upper portion to a lower portion and enclosing an open area adjacent said upper portion, a dished portion for receiving material to be consumed by a pet, said dished portion extending inwardly from the upper portion of said sidewall, a bottom wall extending beneath said dished portion and connected around the lower portion of said sidewall, and a suction cup held beneath a central portion of said bottom wall and extending to underlie at least a major portion of the lateral extent of the dished portion of the bowl and adapted to be secured to a support surface to hold the pet bowl in place as a pet consumes material within said dished portion, said central portion being domed shape to conform generally to the contours of said suction cup.

2. A bowl for holding material to be consumed by a pet, including a sidewall extending from an upper portion to a lower portion and enclosing an open area adjacent said upper portion, a dished portion for receiving material to be consumed by a pet, said dished portion extending inwardly from the upper portion of said sidewall, a bottom wall extending beneath said dished portion and connected around the lower portion of said sidewall, and a suction cup held beneath a central portion of said bottom wall and extending to underlie at least a major portion of the lateral extent of the dished portion of the bowl and adapted to be secured to a support surface to hold the pet bowl in place as a pet consumes material within said dished portion, said central portion being domed shape to conform generally to the contours of said suction cup, said lower portion of said sidewall having an opening, and a tab upstanding from said suction cup and accessible through said opening for releasing the suction cup from the surface.

3. A bowl as set forth in claim 2, said suction cup having an upstanding knob adapted to be press-fitted through an opening in said central portion.

4. A bowl as set forth in claim 3, and projections being formed by a pair of semi-circular ridges arranged concentrically about said knob.

5. A bowl for holding material to be consumed by a pet, including a sidewall extending from an upper portion to a lower portion and enclosing an open area adjacent said upper portion, a dished portion for receiving material to be consumed by a pet, said dished portion extending inwardly from the upper portion of said sidewall, a bottom wall extending beneath said dished portion and connected around the lower portion of said sidewall, and a suction cup held beneath a central portion of said bottom wall and extending to underlie at least a major portion of the lateral extent of the dished portion of the bowl and adapted to be secured to a support surface to hold the pet bowl in place as a pet consumes material within said dished portion, said central portion being domed shape to conform generally to the contours of said suction cup, said suction cup being formed with an integral upstanding knob adapted to be press-fitted through an opening in said central portion.

6. A bowl as set forth in claim 5, and projections being formed by a pair of semi-circular ridges arranged concentrically about said knob.
